(19) United States
(12) Patent Application Publication
(10) Pub. No.: US 2006/0015372 A1
(43) Pub. Date: Jan. 19, 2006

(54) System and method of coordinating medical screening and treatment data

(76) Inventor: Patricia Graham, Newtown, PA (US)

Correspondence Address: SYNNESTVEDT LECHNER & WOODBRIDGE LLP, P O BOX 592, PRINCETON, NJ, 08542-0592, US

(21) Appl. No.: 11/180,941

(22) Filed: Jul. 13, 2005

Related U.S. Application Data
(60) Provisional application No. 60/587,633, filed on Jul. 13, 2004.

(51) Int. Cl. G06K 13/00

(52) U.S. Cl. 705/3

(57) ABSTRACT

A system and method for screening for a medical condition within a network of care in which patents being treated for a secondary medical condition are screened for risk profiles indicative of a risk of having a primary medical condition, and conveying that information to appropriate healthcare providers and authorized community care givers. Patents in healthcare delivery site being treated for a fracture may, for instance, be automatically screened for risk profiles related to osteoporosis. If matches are found, a physician associated with the patient may be informed of the treatment for the secondary condition, and of the potential risk for the primary condition, as well as a request for consideration for evaluative tests and treatments for the primary condition. This may be done by updating a secure electronic database and simultaneously sending the designated physician an email containing the address of the secure electronic database.

### CROSS REFERENCE TO RELATED APPLICATIONS

This application is related to, and claims priority from, U.S. Provisional Patent application No. 60/587,633 filed on Jul. 13^{th}, 2004, by P. Graham entitled “Wellness matrix” the entire contents of which are hereby incorporated by reference.

### FIELD OF THE INVENTION

The present invention relates to the screening and treatment of medical conditions, and more particularly to the screening and treatment of a primary medical conditions by identifying risk profiles and related medical conditions, and screening patents being treated for the related medical conditions for the risk profiles of the primary medical condition and relaying the screening results to primary care physicians or other appropriate, designated physician with the screened patents.

### BACKGROUND OF THE INVENTION

Patients with prior incidence(s) of certain medical conditions, such as fractures, have increased risk of subsequent, repeat occurrence of the condition. This is due, in large part, to many of the patients having related but distinct medical conditions which contribute to the medical condition. Despite this being known, current health management systems treat the existing condition but do not have a clear clinical pathway for evaluating, identifying and treating related conditions which may have contributed to the condition being treated, and likely to precipitate that medical condition if not addressed simultaneously with the medical condition.

For instance, less than 12% of patients with fragility fractures receive adequate osteoporosis evaluation after fracture to reduce recurrent fracture risk and disability. Annual costs of osteoporotic fractures with in the US are tremendous, and by some estimate were as high as $7 billion in 2001. These costs are projected to increase significantly as the average age of the US population increase.

What is needed is a system and method of medical screening and communication that identifies and provides warning of, and treatment for, conditions that are distinct from, but related to a condition currently being treated.

### SUMMARY OF THE INVENTION

Briefly described, the present invention provides a system and method for screening for a medical condition within a network of care in which patients being treated for a secondary medical condition are screened for risk profiles indicative of their higher than average risk of having, or being susceptible to, a primary medical condition, and conveying that information to an appropriate care giver such as, but not limited to, a primary care physician associated with the patient.

In a preferred embodiment, patients in healthcare delivery site such as, but not limited to, an emergency department, being treated for medical conditions such as, but not limited to fragility or other fractures, are screened to ascertain whether they have risk profiles indicative of a higher then average risk of osteoporosis, such as, but not limited to being a peri-menopausal female, a post-menopausal female, a female athlete less than 22 years old or a male at or older than 65 years old.

The screening may, for instance, take the form of screening of patients admitted to the healthcare delivery site. In a preferred embodiment, the patient is asked for permission to convey information to their designated caretaker (i.e., a primary care physician associated with the patient), regarding the diagnosis and treatment for the secondary condition, and of the existence of specific profiles which may indicate increased risk of the primary condition. Tests and treatments for the primary condition would then be discussed by the patient and the designated physician after the secondary condition was deemed appropriately stable (i.e., medically and/or surgically).

Conveying this information to the primary care physician may, for instance, take the form of updating a secure electronic database accessible by the primary care physician, and simultaneously sending the primary care physician an alerting email containing an address indicative of where and how to access secure electronic database.

These and other features of the invention will be more fully understood by references to the following drawings.

### BRIEF DESCRIPTION OF THE DRAWINGS

FIG. 1 is a schematic flow diagram depicting current “standard of care” treatment processing of a patent to be routinely expected when they are admitted to an emergency room with a fracture.

FIG. 2 is a schematic flow diagram depicting a treatment processing of a patent admitted to an emergency room with a fracture in accordance with the present invention.

### DETAILED DESCRIPTION

The present invention relates the screening and treatment of a primary medical condition by identifying its risk profiles and related medical conditions, and screening patents being treated for the related medical conditions for the risk profiles of the primary medical condition and relaying preliminary screening results to appropriate physician(s), family caretakers, and other health care personnel associated with the screened patents.

The system and method of the present invention and the associated software, Artificial Intelligence devices, consulting and training services, provide a healthcare system, whether public (i.e., hospital) or private (i.e., corporate health service), with the virtual healthcare capabilities and services that streamline the system's internal administrative functions, and facilitate delivery of its community health care needs in innovative, cost-effective ways, while raising the standard of medical care.

The system of the present invention may be applied to a variety of identifiable healthcare initiatives including, but not limited to osteoporosis, obesity or bio-terrorism. In a preferred embodiment, the inventive system and methods may be introduced by establishing an electronic matrix of health care options with flexible capacity that addresses both present and anticipated market needs for that identified healthcare initiative. This system and method is designed to be easily integrated into the most commonly utilized hospital medical information systems (MIS), and also to incorporate new technologies, including any suitable applications such as, but not limited to, augmentative Artificial Intelligence applications that become available. In further embodiments, the system and method of this invention utilize proprietary software to provide a virtual healthcare business model that implements identified client goals in the form of a model of interconnecting factors related to optimizing wellness across medical conditions.

In a preferred embodiment of the present invention, augmentative artificial intelligence software and devices are integrated into the existing healthcare software systems and daily healthcare operations to extend and enhance healthcare delivery capabilities without disrupting existing day-to-day operations. In addition, the model of interconnecting factors related to wellness across medical conditions provides a holistic approach that judiciously integrates preventative medicine and so-called alternative medicines into the framework of the more traditional Western healthcare delivery system.

The model of interconnecting factors related to osteoporosis across medical conditions is one specific embodiment of a health initiative model of this invention that can be individualized to a health system's staff strengths and community needs, utilizing the hospital's existing information system as the initial springboard for development of an efficient Virtual Healthcare Delivery System as physician and hospital service extender, as will be described in detail below.

The present invention will now be described in detail with reference to the accompanying drawings in which, as far as possible, like numbers describe like elements.

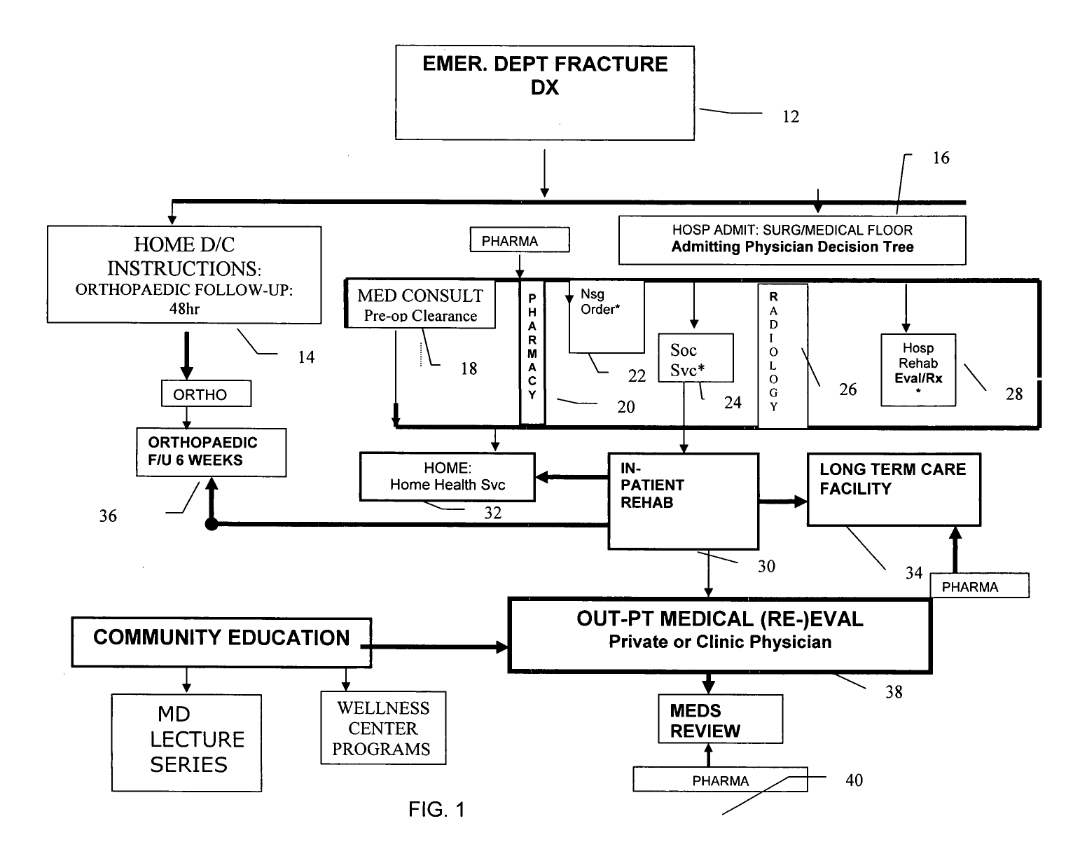

FIG. 1 is a schematic flow diagram depicting current treatment processing of a patent admitted to a healthcare delivery site such as, but not limited to, an emergency room with a fracture. This is a schematic for a clinical pathway for treating a patent with a fracture that represents the way most people are currently treated. The patient is admitted to the healthcare delivery site 12, which in this case is an emergency room, where a diagnosis of the fracture is made. If a small bone or joint is fractured, a splint is applied and the patent proceeds to step 14 in which they are sent home with instructions for an orthopedic follow up within 48 hours. If the fracture is at a large joint or involves a large bone, i.e., requires surgical fixation, the patient enters the hospital surgical floor admittance procedures in step 16. This may include pre-operative clearance which requires a medical (physician) consultant in step 18, consultation with and routine medication services provided by the pharmacy department in step 20, various nursing care and services to carry out physician orders in step 22, consultation with and services provided by the social services in step 24 to facilitate optimal hospital discharge disposition, consultation with and services provided by the radiology department in step 26 pre-and post-operatively, and hospital rehabilitation services in step 28 to prepare the patient functionally for hospital discharge.

On discharge from the hospital, depending on the assessment of medical and surgical staff 16 and 18, social services in set 24, and the in-patient rehabilitation services 30, the patent may go home and have follow up monitoring by home health services in step 32 or the patient may be admitted to a rehabilitation facility 30 to optimize functional capacity after fracture, and determine suitability for community or nursing home (long term health care) 34 disposition. At discharge from hospital, the patient is routinely issued instructions for an orthopedic follow up in step 36; this follow-up is to take place regardless of whether patient becomes a community or nursing home resident at completion of in-patient rehabilitation. At discharge from in-patient rehabilitation services into the community, additional instructions for medical out-patient evaluation/re-evaluation in step 38 is routine. Nursing home disposition implies future medical care will be supervised by nursing home internists.

In this prior art system, the orthopedic surgeon repairs the fracture, but does not communicate with the medical community whether osteoporosis or fragile bones contributed to the fracture. The primary care physician may decide to screen for osteoporosis after the fracture is healed, when the patient appears for their annual visit, but does not communicate back to the orthopedic surgeon the patient screening/treatment results. There is not therefore presently in the USA, nor in the world, a clear business or clinical model for coordinating this public health issue efficiently.

If the patient requires nursing home placement, osteoporosis is rarely treated, and risk for new fractures increases with each year (of hip fracture patients older than age 65,: 25% will require nursing home placement, and of them 50% will die within the year: this is a huge public health and quality of life issue!

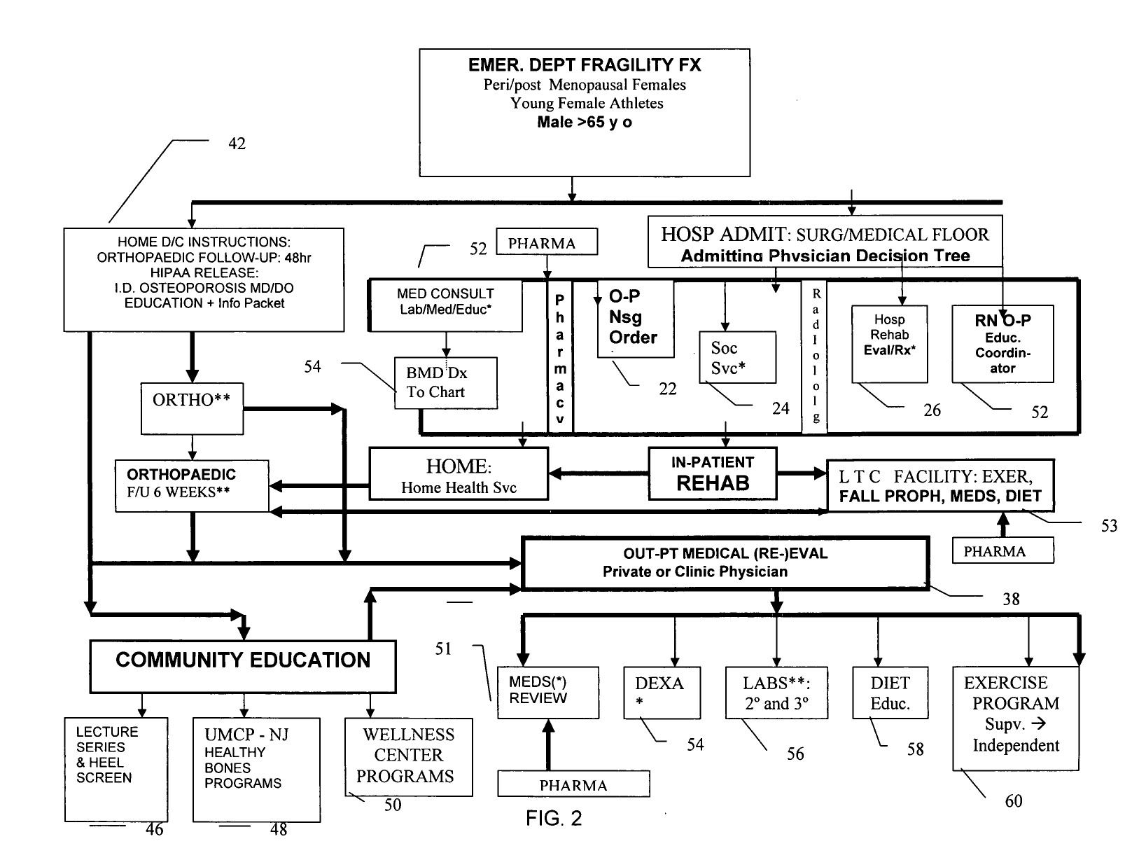

FIG. 2 is a schematic flow diagram depicting a treatment processing of a patent admitted to an emergency room with a fracture such as, but not limited to, a fragility fracture, in accordance with the present invention. This is a schematic depicting a coordinated fracture care program, which captures the four fracture patient categories with the highest likelihood that osteoporosis contributed to the fracture at the time of emergency room evaluation. Although this diagram uses fractures and osteoporosis as a example, one of ordinary skill in the art will readily appreciate that a similar system could be applied wherever there are related, but distinct, medical conditions in which one condition is manifest while the other is not, but may be a contributory or underlying cause of the manifested condition.

The increased number of arrows between boxes is intended to depict increased communication, which may be conducted electronically by, for instance, e-mails, instant messaging or text messaging on cell phones, between physicians, ancillary care providers (physical therapists, nutritionists, etc) and outside hospital facilities (primary care physicians, rehabilitation facilities, etc). One concept with this model of interconnecting factors, or integrated matrix of care (with osteoporosis across medical conditions as an example) is that a patient at risk for any medical condition, could enter the healthcare delivery system from any box and be routed appropriately, electronically, to other physicians, caretakers, research participation opportunities (if desired) to receive the highest level of appropriate education, screening, treatment and follow-up for that medical condition. This integrated system of care facilitates preventative measures, via optimized, electronically-coordinated screening and treatments, to then decrease the risk of a recurrent secondary condition outcome (i.e., a second fracture).

In a preferred embodiment, in step 40, a patient diagnosed in the emergency room with a particular condition, such as a fragility fracture, may then be screened for risk factors for another distinct, related medical condition, such as osteoporosis. If found to be at high risk for osteoporosis, then the patient may be informed of this, and may then acquiesce to receive education about these risks, and pursue further medical evaluation for this identified risk if so desired. By HIPAA guidelines, to facilitate coordination of preventative care, the patient must then designate which physician is to carry out this initiative in step 42. Identification of fracture patients at risk for osteoporosis may be triggered automatically, for instance, with routine daily reviews of emergency room records, with patient fragility fracture diagnosis, history (highest risk factors: menopausal status, males>65 years old, young female athletes with disrupted menses ), and treatment. Identification of a patient with a fragility fracture with a risk profile indicative of a higher than average risk of osteoporosis would require by law a signed HIPPA information release request, and if satisfied, would result in the immediate (electronic) or delayed (phone, fax) transmission of educational materials to the patient, and medical advisement to appropriate healthcare providers and caretakers via printed notes, email, text message, or instant message, each with appropriate security.

Such searching may be done automatically, or semi-automatically, using systems and methods such as those described in U.S. Pat. No. 5,671,404 issued to Lizee et al. on Sep. 23, 1997 entitled “System for querying databases automatically”, the contents of which are hereby incorporated by reference.

The routing of the messages may be done by, for instance, systems and methods such as those described in U.S. Pat. No. 6,857,074 issued to Bobo on Feb. 15, 2005 entitled “Systems and methods for storing, delivering, and managing messages”, the contents of which are hereby incorporated by reference.

For instance, if a minor fracture occurs, and only a splint is required, the patient proceeds in step 42 to discharge with instructions for an orthopedic follow up in 48 hours. If the patient is in a high risk osteoporosis category, and agrees to consider medical (re-)evaluation for same, a HIPPA release is signed, the patent designates one physician or diagnostic center to pursue evaluation, additional education or information packages are provided related to osteoporosis which can be tailored to the patient's particular risk factor(s); this information may include the identification of local community education facilities, and any relevant lecture series 46, state-sponsored Healthy Bones Programs 48 and hospital-based wellness center programs 50 with holistic practices and exercise programs specifically designed to improve bone density, and reduce bone injury while exercise. If appropriate release is obtained, there may also be a message sent to any of the community education facilities providing appropriate contact information so that each of those programs may take appropriate action such as, but not limited to, including the patient at risk on an e-mailing list. Additionally, the standard orthopedic notification of impending patient contact for follow-up includes an advisement that the patient may benefit from osteoporosis (re-) evaluation. The designated osteoporosis physician or diagnostic center is also notified of patient's interest for further work-up and signed agreement to share medical information within hospital's integrated matrix of care.

If the fracture is more serious, i.e., requires surgery, the patient enters the hospital surgical floor admittance procedures in step 16. In addition to the standard procedures, the pre-operative clearance with the medical consultant assigned by the orthopedic surgeon may further include in step 18 a designated staffperson for osteoporosis patient education services/research gathering capability (questionnaires), expanded osteoporosis medication availability and consultation expertise provided by the pharmacy department in step 20, expanded nursing orders with regards to osteoporosis and fall and fracture risks in step 22, additional notification to the social services department of patient's identified osteoporosis risk status in step 24, coordination electronically with the radiology department in step 26 to include assessment of bone density status within fracture x-ray reports and expanded hospital rehabilitation services in step 28 to include specialized attention to fracture risk with exercise, expanded fall and balance assessment and tailored exercise program to improve bone health.

In the preferred embodiment, on discharge from the hospital, now depending on the assessment of social services in set 24 as to optimal initial community disposition setting (with input from the hospital rehabilitation unit, patient's community caretakers and medical/surgical staff), the patent may go home or may be admitted to an inpatient rehabilitation care facility.

If the patent is sent home, they will have instructions for a follow-up visit to an orthopedic office, usually at 4-6 weeks; this orthopedic office will have been informed of any risk factors for osteoporosis or of the evaluation and treatment for osteoporosis begun by hospital rehabilitation in step 26 by standard discharge instruction sheet footnoted with recommendation for osteoporosis (re-evaluation). If appropriate, home health services can be provided, but with strict osteoporosis exercise guidelines, home safety evaluation and nursing assistance in coordinating office appointments with designated physician or diagnostic center for further assessment of osteoporosis status where osteoporosis risk status warrants.

If the patent is admitted to an in-patient rehabilitation facility in step 53, the care facility will be informed of the appropriate exercise, fall prevention strategies, medications and diets appropriate for the osteoporosis risk status by, for instance, addendae to standard discharge transfer sheet instructions, including the name of designated osteoporosis physician or diagnostic center for out-patient follow-up after fracture is healed.

The information may also be disseminated by, for instance, creation of, or incorporation into appropriate clinical pathway templates of the sort described in U.S. Pat. No. 6,434,531, issued on Aug. 13, 2002 and assigned to Clinicomp International, Inc. of San Diego, Calif., entitled “Method and system for facilitating patient care plans”, the contents of which are hereby incorporated by reference.

Because of the forwarding of information regarding related conditions, when the patient goes for out-patient medical re-evaluation in step 38, the physician and the patient will discuss both the routine primary condition, i.e. the fracture, but also the related condition, i.e., the osteoporosis screening status. This discussion and education may include review of appropriate osteoporosis medications in step 51, of the need for bone density testing by, for instance, dual-energy X-Ray absorptiometry (DEXA) testing, of other suitable osteoporosis screening laboratory testing in step 56, of expanded dietary goals such as, but not limited to, increased calcium and Vitamin D, in step 58 and of appropriate exercise programs in set 60.

The potential efficacy of such a coordinated program can be gauged by research that has shown that after first fracture, a person with osteoporosis has a 2-5× higher risk of second fracture if no treatment intervention occurs.

For any identified healthcare initiative, the method of the present invention may be applied, providing a unique interdisciplinary model of health systems management that in turn requires expanded training of administration, medical and ancillary care staff and routine support service personnel. This model presupposes a group ethic: equal but different contributions from all personnel within the system in their chosen work responsibility, and a respectful interdependence which actualizes system goals more readily than a hierarchical approach. It encompasses every aspect of daily hospital operations, and can be evaluated/revised via specialized goal-tracking software. This model system concept underlies all program implementation policy, and contributes to healthcare delivery innovation and efficiency, and team-building through common purpose. The necessary staff development program may be developed and implemented as described below in the “heads up” training.

In one embodiment of the present invention, there is a tiered physician services' approach in which the primary tier are the physicians most likely to identify, prevent and/or treat the primary condition (i.e., osteoporosis), while the secondary tier physicians are those most likely to encounter/induce patients with risk factors for the primary condition and refer patients for treatment. For example, in a preferred embodiment of the model of interconnecting factors related to osteoporosis across medical conditions, the primary tier physicians may, but are not limited to, the radiologists (diagnostic), emergency physicians, the endocrinologists (screening/ treatment), gynecologists, orthopedic surgeons, rheumatologists, physiatrists, primary care physicians (treatment) and pediatricians (preventative). Secondary tier physicians are less likely to diagnose, treat or prevent the primary condition of concern, i.e. in this embodiment, osteoporosis, but they are likely to encounter a subset of their patients who they treat for possibly related conditions and whom, through the implementation of the screening methods of this invention, they will then refer to one or more of the first tier physicians such as, but not limited to, the treating physicians. Secondary tier physicians may include, but are not limited to, urologists, as prostate cancer treatments can induce osteoporosis; psychiatrists, who see eating disorder patients that may be at risk for osteoporosis, nephrologists, as renal failure can induce osteoporosis; and pulmonologists, as tobacco abuse or steroid treatment for lung disease can induce osteoporosis. The targeted physician-tiered treatment model is intended to optimize physician expertise, face-to-face patient time and communication, and to raise the standard of care for prevention and treatment of medical conditions while minimizing cost outlays for new program inception, while preserving physician autonomy.

In a further embodiment of the invention, the inventive concepts are implemented via a nurse-driven infrastructure that provides the physician and administration directives for each of the Identified Healthcare Initiatives. The established 24-hour service nursing network can be leveraged by expanding the traditional nursing practices to incorporate one or more of the elements of the model of interconnecting factors related to wellness across medical conditions of the present invention including, but not limited to, promoting and implementing the expansion of virtual healthcare capabilities, improving communication between patients and staff, and the hospital and community healthcare partners, reducing medical errors, and providing essential research and program oversight. A new level of efficiency in healthcare delivery may be achieved, while reducing cost of service delivery.

In a further embodiment of the present invention, there is an internet-driven extension of health care service capabilities including, but not limited to updating designated physicians by e-mail, and providing computer driven options tailored to specific health initiatives, and maintaining secure databases by secured internet connections. Such a system may incorporate systems such as those described in, for instance, U.S. Pat. No. 6,321,203 issued to Kameda on Nov. 20, 2001 entitled “Medical care schedule and record aiding system and method”, or U.S. Pat. No. 6,154,726 issued to Rensimer et al. on Nov. 28, 2000, entitled “System and method for recording patient history data about on-going physician care procedures” and U.S. Pat. No. 6,915,308 issued to Evans et al. on Jul. 5, 2005 entitled “Method and apparatus for information mining and filtering”, the contents of all of which are hereby incorporated by reference.

In a further embodiment of the invention, health initiative software provides medical and ancillary staff flexible clinical pathway guidelines, with Internet cueing options available during the ordering and data retrieval processes to prompt learning and familiarity with particular healthcare systems services and medical research updates. In a preferred embodiment, this may be implemented to include optimal plans for appropriate care occurring in both in- and out-patient settings. Expanded medical decision trees may be routinely updated for physicians, without disrupting daily hospital operations. HIPAA and internet security protections may be incorporated into these programs.

In a further embodiment, Artificial Intelligence devices such as wrist bands encoded with health history and recent updated care data, may, in conjunction with the afore-mentioned cued clinical pathway assistance capabilities be utilized to readily identify patients at presentation for medications, testing and physical evaluation, reliably and efficiently facilitate retrieval patient medical history, facilitate and expand communication between healthcare professionals and patients, reduce medical errors, deliver healthcare more efficiently with less need for personnel-driven communication, facilitate medical care delivery by healthcare providers and administration, and improve communication with Community Health Partners during critical patient transition periods (i.e., transfer from hospital to rehabilitation facility, at follow-up visits after in-patient care). This technology may be carried on the patient's person in microchip form (wristband, as above) to facilitate all patient services. Such a system may be incorporated in, for instance, and RFID tag such as those described in, for instance, U.S. Pat. No. 6,535,129 issued to Petrick on Mar. 18, 2003 entitled “Chain of custody business form with automated wireless data logging feature”, the contents of which are hereby incorporated by reference.

In a further embodiment, selected healthcare initiatives may provide opportunity for virtual consulting by physicians and other healthcare professionals via the Internet (for example, dermatologic consults).

In a further embodiment, the establishment of Internet-secure communication networks within the matrix of care may be used to update staff to on-going hospital initiatives and concerns.

In a further embodiment, participation in national and international research data banks via HIPAA compliant access to patient healthcare system internet medical records may be implemented.

In a further embodiment, integrated medicine preventative healthcare protocols may be implemented on all health initiatives. The business model of this invention provides expertise to clients in incorporating appropriate Holistic Medicine practices into new health initiatives to optimize Preventive Health Outcomes. These efforts reduce morbidity and mortality, thus lowering healthcare costs while improving healthcare delivery, patient participation in care and patient satisfaction. For example, there is solid scientific evidence that the regular practice of Tai Chi improves balance and attention, decreases the incidence of falls, and improves bone mineral density in osteoporosis patients. Tai Chi practice could then be incorporated into a hospital system's Wellness Center offerings, with referrals by physicians from both First Tier and Second Tier classifications as part of Preventive Health initiatives for osteoporosis, fracture reduction and bone health. Tai Chi in a pool setting (termed Ai Chi) could be offered to patients with both osteoporosis and severe arthritis, to reduce exercise-induced joint pain that might be more likely with Tai Chi performed on land. Educating physicians and other healthcare personnel about the benefits of exercise as a “preventative” health measure for many disease conditions is also recommended as a basic tenet of care in the Integrative Medicine approach.

Implementation of a model of interconnection factors related to wellness across medical conditions establishes an improved standard for healthcare delivery by decreasing inefficiencies and poor communication which have defined obsolete healthcare delivery patterns of the last century, with increased overhead, physician and nursing errors and associated medicolegal risks its past hallmarks.

The model is intended to increase staff loyalty and decreases staff turnover with its tailoredstaff development programs which, for example, instill respect for every individual's contribution to creating a hospital system that is greater than the sum of its parts.

The model is intended to further encourage commitment to personal excellence in all aspects of healthcare service delivery

The model is intended to continually challenge staff to expand their expertise in telemedicine and new dimensions of healthcare delivery, and contribute to the evolution of this innovative approach to pervasive healthcare delivery challenges

The model is intended to encourage all individuals to avail themselves of preventive medicine options within their healthcare system as part of employee health initiatives

The model is intended to deepen their identity with, pride in and loyalty to their healthcare organization with focused education programs which challenge and team-build.

The may further facilitate a healthcare system's development of an expanding array of healthcare innovations for use in their community to build hospital brand loyalty, for example:

Expanding the scope of patient and caregiver access to medical data electronically, while protecting privacy to current HIPAA standards.

Expanding the frontiers of telemedicine to allow individuals access to their Preferred Healthcare Profile at any point in time, from any point on Earth if needed to facilitate urgent care.

Providing Individualized Interactive Websites for children and adults for access from home or in approved hospital sites (in-hospital, in partnered community facilities and at community events). These can provide information about existing and upcoming hospital education events and new staff, technologies and services.

Facilitating cutting-edge research initiatives, which further the integration of electronic technology and holistic care options within the health care delivery system.

In a further embodiment of the invention, software may be made available to track outcomes for all program goals, for example:

Status of Healthcare Initiatives within the hospital system,

Efficacy of delivery of existing and new healthcare services,

Projected benefits of innovative preventive health care initiatives, in decreased morbidity, mortality and cost of delivery to preferred third-party payors,

Increased patient and staff satisfaction, and

Continued evolution of system facilities/services to community and generational needs.

Standard marketing and accounting system data retrieval needs may be incorporated into the software capabilities of the present invention, thereby providing state-of-the-art access to accounts payable and accounts receivable data, for up-to-the-minute tracking of patient, health care provider and third-party payor data. This allows the hospital administration to address patient and provider queries, and assess the financial health of the organization in an on-going fashion, while providing HIPAA-compliance and Internet-secure protection.

The pursuit of healthier lifestyles and higher quality of life with both traditional Western medicine advances and incorporation of preventive/holistic lifestyle changes is on the rise. The healthcare education market has been expanding geometrically as a result, with new advances in teaching technology, and increasing public competence in exploring virtual reality concomitant with this explosion of ideas. The model of this invention provides a healthcare system distinct advantages in the healthcare delivery marketplace by developing expertise in 1) an innovative interdisciplinary model of medical management, 2) telemedicine and artificial intelligence applications, and 3) gaining enthusiastic support and loyalty from hospital staff, patients and community partners in raising the standard of healthcare delivery. This program creates a new public health model that improves quality and efficiency of care, reduces morbidity with strikingly innovative preventive healthcare initiatives and raises patient satisfaction levels.

The model of this invention may accomplish this by facilitating the development of a flexible hospital management style, which adapts readily to changes in technology and to community healthcare needs.

This may include, but is not limited to, software that can provide a diversity of clinical pathways to integrate new information models into an easy-to-use format, which can then be applied to varied patient populations and medical conditions, from charity clinics to high-tech post-operative patients, to assess patient needs and interests. This is a flexible software and health care delivery model that can be adapted to any health care need, from multi-faceted medical issues like osteoporosis or cancer care, to preventive health issues like diabetes and cardiac care, and to cutting-edge surgical techniques such as bariatric surgery or computer-driven neurosurgery imaging techniques. It can increase patient and staff awareness of higher-level human capabilities in the exciting areas of telemedicine, and personal communication device applications. It presupposes the development of health initiatives which encompass the human interest in higher-level wellness, and its merging with medical expertise in the new field of integrative medicine, mind-body medicine research and artificial intelligence.

The model of this invention may be a way to naturally evolve an expanding, dynamic healthcare system, and provides a highly interactive internet presence for the hospital with its world community. This is in essence the frontier of 21st century medicine: the creation of a virtual healthcare system which in its simplest application is community-building and profit-building for any healthcare system, and in its broadest applications, can redefine the integration of tele-communication capabilities and the real-world, real-time health needs of humanity.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for screening for a medical condition within a network of care, comprising the steps of:
identifying one or more risk profiles indicative of a higher than average risk of a first medical condition;
identifying a second medical condition related to, but distinct from, said medical condition;
identifying a patent being treated for said second medical condition in a healthcare delivery site and having one or more of said demographic factors; and
informing a physician associated with said patient of said treatment for said second medical condition in said healthcare delivery site, and of said one or more risk profiles indicative of a higher than average risk of said second, related medical condition.

2. The method of claim 1 further comprising obtaining a patent consent to inform said physician associated with said patient of said treatment for said second medical condition in said healthcare delivery site, and of said one or more risk profiles indicative of a higher then average risk of said second, related medical condition.

3. The method of claim 1 wherein said step of identifying a patent being treated for said second medical condition in said healthcare delivery site and having one or more of said risk profiles further comprises searching an electronic data base containing one of more case histories of patients treated in said emergency care facility.

4. The method of claim 3 wherein said step of informing said physician further comprises securely updating a secure electronic database accessible by said physician and sending said physician an alerting email containing an address indicative of a said secure electronic database.

5. The method of claim 1 wherein said first medical condition is osteoporosis and said one or more risk profiles indicative of a higher then average risk of osteoporosis is selected from the group consisting of a peri-menopausal female, a post-menopausal female, a female athlete less than 18 years old and a male older than 65 years old.

6. The method of claim 5 wherein said second medical condition is a fragility fracture.

7. The method of claim 6 wherein said step of identifying a patent being treated for said fragility fracture in said healthcare delivery site and having one or more of said risk profiles further comprises searching an electronic data base containing one of more case histories of patents treated in said healthcare delivery site.

8. The method of claim 7 wherein said step of informing said physician further comprises securely updating a secure electronic database accessible by said physician and sending said physician an alerting email containing an address indicative of a said secure electronic database.

9. A system for screening for a medical condition with in a network of care, comprising:
means for identifying one or more risk profiles indicative of a higher than average risk of a first medical condition;
means for identifying a second medical condition related to, but distinct from, said medical condition;
means for identifying a patent being treated for said second medical condition in an healthcare delivery site and having one or more of said demographic factors; and
means for informing a physician associated with said patient of said treatment for said second medical condition in said healthcare delivery site, and of said one or more risk profiles indicative of a higher then average risk of said second, related medical condition.

10. The system of claim 9 further comprising means for obtaining a patent consent to inform said physician associated with said patient of said treatment for said second medical condition in said healthcare delivery site, and of said one or more risk profiles indicative of a higher then average risk of said second, related medical condition.

11. The system of claim 11 wherein said means for identifying a patient being treated for said second medical condition in healthcare delivery site and having one or more of said risk profiles further comprises means for searching an electronic data base containing one of more case histories of patient's treated in said healthcare delivery site.

12. The system of claim 11 wherein said means for informing said physician further comprises means for securely updating a secure electronic database accessible by said physician and means for sending said physician an alerting email containing an address indicative of a said secure electronic database.

13. The system of claim 9 wherein said first medical condition is osteoporosis and said one or more risk profiles indicative of a higher then average risk of osteoporosis is selected from the group consisting of a peri-menopausal female, a post-menopausal female, a female athlete less than 22 years old with disrupted menses or unknown nutritional status, and any male at or older than 65 years old.

14. The system of claim 13 wherein said second medical condition is a fragility fracture.

15. The system of claim 14 wherein said means for identifying a patent being treated for said fragility fracture in said healthcare delivery site and having one or more of said risk profiles further comprises means for searching an electronic data base containing one of more case histories of patents treated in said emergency care facility.

16. The system of claim 15 wherein said means for informing said physician further comprises means for securely updating a secure electronic database accessible by said physician and means for sending said physician an alerting email containing an address indicative of a said secure electronic database.
